(19) United States
(12) Patent Application Publication
(10) Pub. No.: US 2024/0051474 A1
(43) Pub. Date: Feb. 15, 2024

(54) MOUNTING DEVICE FOR MOUNTING A SENSOR ON A VEHICLE COMPONENT AND VEHICLE COMPONENT WITH MOUNTING DEVICE

(71) Applicant: Volkswagen Aktiengesellschaft, Wolfsburg (DE)

(72) Inventors: Alexander Tietje, Wesendorf (DE); Ansgar Nortmann, Gifhorn (DE); Sebastian Seidler, Wasbüttel (DE); Frank Gerstenkorn, Wolfsburg (DE)

(21) Appl. No.: 18/448,036

(22) Filed: Aug. 10, 2023

(30) Foreign Application Priority Data
Aug. 12, 2022 (DE) 102022208407.1

(51) Int. Cl. B60R 11/00; G01D 11/30

(52) U.S. Cl. CPC B60R 11/00; G01D 11/30; B60R 2011/005; G01S 7/521

(57) ABSTRACT

A mounting device for mounting a sensor on a vehicle component, including a mounting base with an opening for a receiving element of a sensor and at least one securing mechanism. The mounting base or the securing mechanism includes at least one fastening receptacle, and wherein the at least one securing mechanism or the mounting base has at least one fastening element, wherein the at least one securing mechanism is secured to the mounting base by arranging the at least one fastening element in the at least one fastening receptacle. The at least one securing mechanism is configured to secure a sensor arranged on the mounting base at least in the axial direction. The at least one fastening element and the at least one fastening receptacle form a rotary closure by inserting the at least one fastening element into the at least one fastening receptacle and rotating the securing mechanism.

### CROSS REFERENCE TO RELATED APPLICATION

The present application claims priority to German Patent Application No. DE 10 2022 208 407.1, to Tietje, et al., filed Aug. 12, 2022, the contents of which is incorporated by reference in its entirety herein.

### FIELD OF TECHNOLOGY

The present disclosure relates to a mounting device for mounting a sensor on a vehicle component, comprising a mounting base having an opening for a receiving element of a sensor and at least one securing mechanism. Furthermore, the present disclosure relates to a vehicle component having a mounting device.

### BACKGROUND

Modern motor vehicles have a large number of sensors. Some of the sensors, such as ultrasonic sensors, have an exposed position on the vehicle due to their design and function. Since ultrasonic sensors, in particular, can interfere with the vehicle's braking system depending on their function, there are strict requirements regarding the tight fit and the maximum adjustment angle of the ultrasonic sensors. Because ultrasonic sensors, in particular, can interfere with the vehicle's braking system, there are strict requirements for the tight fit and maximum angle of adjustment of the ultrasonic sensors. These two requirements conflict with each other.

The consequences of a misaligned or detached sensor can have safety implications. A misaligned ultrasonic sensor can provide erroneous signals, resulting in premature or even late braking system intervention if obstacles are not detected or are incorrectly detected. The ultrasonic sensors can become detached or misaligned even from low-speed bumps while parking.

An ultrasonic sensor for a driver assistance system of a vehicle is known from DE 10 2017 123 403 A1, having a basic housing body with a transmitting and receiving membrane arranged on the front side for transmitting and receiving ultrasonic waves and with a housing cover, wherein a housing opening of the basic housing body arranged in particular on the rear side can be closed by the housing cover, the housing cover is formed integrally with the basic housing body and the housing cover is connected to the basic housing body by a film hinge.

DE 10 2017 123 401 discloses a further ultrasonic sensor for a driver assistance system of a vehicle, having a basic housing body with a transmitting and receiving diaphragm arranged on the front side for transmitting and receiving ultrasonic waves, and having a housing cover, wherein a housing opening, in particular arranged on the rear side, of the basic housing body can be closed by the housing cover, wherein the housing cover has a latching geometry that is at least partially circumferential with respect to a circumference of the housing opening, and wherein the housing base body has a latching geometry that is at least partially circumferential with respect to the circumference of the housing opening, wherein the latching geometry of the housing cover is designed to correspond to the latching geometry of the housing base body in order to fix the housing cover to the housing base body.

A sensor arrangement for a motor vehicle body is known from DE 10 2015 016 206 A1. The sensor arrangement comprises a mount which can be arranged on the motor vehicle body and has a receptacle, a sensor which can be inserted into the receptacle, the sensor having at least one fastening element which can be brought into positive engagement with at least one counter-fastening element provided on the receptacle in order to fix the sensor in the receptacle, and having at least one elastic damping element between the fastening element and the counter-fastening element.

### SUMMARY

Aspects of the present disclosure are directed to providing a mounting device for mounting a sensor on a vehicle component, which prevents unwanted loosening or shifting of the sensor and limits the forces to be applied by an operator for mounting.

In some examples, a mounting device for mounting a sensor on a vehicle component is disclosed, comprising a mounting base with an opening for a receiving element of a sensor and at least one securing mechanism, wherein a sensor can be arranged on the mounting base in an axial direction, wherein the mounting base has at least one fastening receptacle and wherein the at least one securing mechanism has at least one fastening element, or wherein the at least one securing mechanism has at least one fastening receptacle and wherein the mounting base has at least one fastening element, wherein the at least one securing mechanism can be secured to the mounting base by arranging the at least one fastening element in the at least one fastening receptacle, wherein the at least one securing mechanism is configured to positively secure a sensor arranged on the mounting base at least in the axial direction, wherein it is further provided that the at least one fastening element and the at least one fastening receptacle form a rotary closure by inserting the at least one fastening element into the at least one fastening receptacle and rotating the securing mechanism.

The mounting device may be configured for mounting a sensor to a vehicle component.

The sensor may be, for example, an ultrasonic sensor. However, it may also be a camera device or a radar or LIDAR sensor.

The vehicle component may be, for example, a bumper or a fender of the motor vehicle.

The mounting device may be formed integrally with the vehicle component or may be attached to the vehicle component by known methods.

The mounting device may be configured to hold or receive a sensor. In addition, the mounting device may already comprise the sensor, so that the present disclosure also relates to a mounting device comprising a sensor.

In some examples, a vehicle component is disclosed, having the mounting device as described herein.

Preferably, the vehicle component comprises a sensor which is arranged in the mounting device.

### BRIEF DESCRIPTION OF THE DRAWINGS

The present disclosure will be explained in more detail below with reference to the accompanying figures. Specifically:

FIG. 1 is an exploded view of a first mounting device, according to some aspects of the present disclosure;

FIG. 2 is a first perspective view of the first mounting device, according to some aspects of the present disclosure;

FIG. 3 is a second perspective view of the first mounting device, according to some aspects of the present disclosure;

FIG. 4 is a sectional view of the first mounting device, according to some aspects of the present disclosure;

FIG. 5 is an exploded view of a second mounting device, according to some aspects of the present disclosure;

FIG. 6 is a first perspective view of the second mounting device, according to some aspects of the present disclosure;

FIG. 7 is a second perspective view of the second mounting device, according to some aspects of the present disclosure;

FIG. 8 is an exploded view of a third mounting device, according to some aspects of the present disclosure;

FIG. 9 is a first perspective view of the third mounting device, according to some aspects of the present disclosure;

FIG. 10 is a second perspective view of the third mounting device, according to some aspects of the present disclosure; and

FIG. 11 is a sectional view of the third mounting device in the region of a mounting base according to some aspects of the present disclosure.

### DETAILED DESCRIPTION

In the figures, identical or corresponding elements are indicated by the same reference signs.

In some examples, a mounting device as disclosed herein comprises a mounting base and at least one securing mechanism. The mounting base has an opening for a receiving element of a sensor. If the sensor is an ultrasonic sensor, its receiving and transmitting membrane for ultrasonic waves is arranged in or in the region of the opening, so that the sensor can transmit and receive ultrasonic signals through the opening, respectively. The axial direction is preferably perpendicular to the plane in which the opening is located.

The mounting base may be configured with at least one fastening receptacle and the securing mechanism has at least one fastening element. Alternatively, or additionally, the at least one securing mechanism may also comprise at least one fastening receptacle and the mounting base may comprise at least one fastening element. To attach the securing mechanism to the mounting base, the securing mechanism is brought to the mounting base and the at least one fastening element is inserted into the at least one fastening receptacle.

When the sensor and the securing mechanism are arranged or attached to the mounting base, the securing mechanism positively secures the sensor at least in the axial direction. In particular, this means that the form fit prevents the sensor from coming loose from the mounting base in the axial direction.

According to the present disclosure, the at least one fastening element and the at least one fastening receptacle form a rotary closure by inserting the at least one fastening element into the at least one fastening receptacle and rotating the securing mechanism. The rotary closure connects the securing mechanism to the mounting base.

An advantage of the configurations of the present disclosure is that the forces to be applied by an operator to form the rotary closure by rotating the securing mechanism are low. At the same time, the securing mechanism connected to the mounting base by means of a rotary closure provides a positive securing of the sensor in the axial direction.

Advantageously, it is provided that the rotation takes place in a plane perpendicular to the axial direction.

Furthermore, it can be configured such that the rotation of the securing mechanism for forming the rotary closure is less than 20°, preferably less than 10°, particularly preferably less than 5°.

Thus, the rotary closure is preferably not a screw closure.

Preferably, the at least one fastening receptacle is a recess which is at least partially aligned in a circumferential direction of the mounting base or the securing mechanism and has an insertion opening.

When the securing mechanism is brought close to the mounting base so that the fastening means comes close to the fastening receptacle, the fastening means can be inserted through the insertion opening into the fastening receptacle formed as a recess. Rotation of the securing mechanism then forms the rotary closure.

It is advantageously provided that the at least one fastening element is pin-shaped or bolt-shaped or plate-shaped.

In some examples, the fastening means (also referred to as “fastening mechanism”) can be a pin-shaped or bolt-shaped or plate-shaped projection on the mounting base or on the securing mechanism. In addition, the fastening means can be a pin-shaped or bolt-shaped or plate-shaped portion of the mounting base or the securing mechanism.

In some examples, the fastening element is complementary to the fastening receptacle and/or the recess. For example, if the recess is formed substantially as a rectangular slot, it is convenient to form the fastening element as a plate-shaped portion. If the recess is substantially round, a pin-shaped or bolt-shaped fastening means is advantageous.

In some examples, the insertion opening is oriented in the circumferential direction, or that the insertion opening is oriented in the axial direction, preferably in the axial direction in the direction of the opening for the receiving element. If the insertion opening is oriented in the axial direction, preferably in the axial direction in the direction of the opening for the receiving element, the rotary closure is preferably a bayonet-type rotary closure.

Thus, depending on the orientation of the insertion opening, the fastening element is inserted into the insertion opening and thus into the recess in different ways. When the insertion opening is oriented in the circumferential direction, the fastening element is disposed in the circumferential direction adjacent to the insertion opening, and by rotating the securing mechanism, the fastening element is inserted through the insertion opening. Continued rotation produces the rotary closure.

When the insertion opening is aligned in the axial direction, the fastening element is inserted into the insertion opening by moving the securing mechanism in the axial direction toward the mounting base. Once the fastening element is inserted through the insertion opening into the recess, rotation of the securing mechanism occurs to form the rotary closure.

In some examples, at least one fastening receptacle and the at least one fastening element are configured to form a snap connection or a latch connection or a clip connection. In other words, the fastening element may latch into the fastening receptacle when the rotary closure is formed to prevent unintentional release of the securing mechanism from the mounting base.

Appropriate latching elements may be provided on the mounting base or on the securing mechanism to form the snap, latch, or clip connection. For example, the latching elements may be in the form of inclined planes or wedges. However, it is also possible for the insertion opening to have a smaller diameter than the remainder of the recess so that the fastening element latches into the recess when inserted through the insertion opening.

In some examples, the mounting base includes a receiving portion for the sensor extending substantially in the axial direction away from the opening, in which receiving portion the sensor can be arranged, wherein the at least one fastening receptacle of the mounting base or the at least one fastening element of the mounting base is arranged at an end of the receiving portion facing away from the opening, preferably at an edge region facing away from the opening.

In this case, the mounting base thus comprises, in addition to the opening for the receiving element of the sensor, a projection which extends substantially in the axial direction away from the opening and which is designed to receive the sensor. The receiving portion may be substantially cylindrical with a circumferentially closed wall. Alternatively, the receiving portion can have a plurality of support arms extending in the axial direction away from the opening of the mounting base.

In this case, it can preferably be provided that the securing mechanism can be attached to the end of the receiving portion facing away from the opening, preferably to the edge region facing away from the opening, in such a way that a form-fitting portion of the securing mechanism engages behind and/or bridges over a sensor arranged in the receiving portion on a side of the sensor facing away from the opening.

By the form-fitting portion engaging behind or bridging the side of the sensor facing away from the opening, the sensor is secured by the securing mechanism at least in the axial direction.

In some examples, the securing mechanism may be configured as a pin or bolt, wherein the form-fitting portion is a central part of the pin or bolt, and wherein a respective fastening element is arranged at the end of the central part. In this case, the receiving portion of the mounting base has the at least one fastening receptacle that is arranged at an end of the receiving portion facing away from the opening, preferably at an edge region facing away from the opening.

In some examples, at least two fastening receptacles are provided, which are arranged opposite each other at the edge region of the receiving portion. The securing mechanism, which is in the form of a pin or bolt, is then secured with the portions located at the ends of the central part in a respective fastening receptacle, so that the central part, as a form-fitting portion, engages behind and/or bridges over a sensor arranged in the receiving portion on a side of the sensor facing away from the opening.

The fastening elements may be those portions of the pin or bolt which are directly adjacent to the form-fitting portion or to the central part of the pin or bolt. In terms of their geometric design, particularly their diameter, the fastening elements may be identical to the central part or the form-fitting portion. In principle, however, it is also possible that the fastening elements, i.e., the portions directly adjacent to the central portion of the pin or bolt, have a larger or smaller diameter than the central part.

In some examples, the fastening elements may be located at the ends of the central part are followed by material thickenings.

This configuration is particularly useful when the fastening elements located at the end of the central part have a diameter equal to or greater than the diameter of the central part. In this case, the material thickenings engage behind the fastening receptacles or recesses provided in the end of the receiving portion facing away from the opening and prevent axial slipping of the securing mechanism designed as a pin or bolt, so that the pin or bolt cannot slide out of the fastening receptacles or recesses in its own axial direction. In some examples, the pin or bolt is made of a plastic or a metal.

In some examples, the securing mechanism includes a ring portion surrounding the end of the receiving portion facing away from the opening, preferably the edge region facing away from the opening, on the outside or inside, the ring portion having the at least one fastening receptacle, and the form-fitting portion being a bracket extending transversely over the ring portion. In this case, the at least one fastening mechanism may be arranged at the end of the receiving portion facing away from the opening, which fastening mechanism is preferably formed as a pin-shaped or bolt-shaped or plate-shaped projection on the mounting base.

The ring portion need not necessarily be a circular portion. It is only essential that the ring portion externally or internally surrounds the edge region facing away from the opening or the end of the receiving portion facing away from the opening.

In the configuration of the securing mechanism with the ring portion, it is preferably provided that the insertion openings of the fastening receptacles or of the recesses are aligned in the axial direction with the openings of the mounting base. The fastening receptacles or recesses of the securing mechanism, together with the fastening elements of the mounting portion, then form a bayonet-type rotary closure.

In this embodiment, the form-fitting portion of the securing mechanism is a bracket that extends transversely across the ring portion. Thus, after a sensor has been inserted into the receiving portion in an axial direction with respect to the mounting base, the securing mechanism is then secured to the end of the receiving portion facing away from the opening by the rotary closure, in particular the bayonet-type rotary closure.

The bracket extending transversely over the ring portion is then arranged on the side of the sensor facing away from the opening of the mounting base and engages over this side. This prevents axial loosening of the sensor from the mounting base and in particular from the mounting device. In some examples, the bracket is elastic, in particular spring-elastic. Furthermore, the bracket and/or the ring portion may be made of a plastic or a metal.

In some examples, the securing mechanism may be configured with a receiving portion for the sensor which, in the state arranged on the mounting base, extends substantially in the axial direction away from the opening, wherein the sensor can be arranged in the receiving portion, wherein the receiving portion has form-fitting portions at the end facing away from the opening, preferably at the edge region facing away from the opening, wherein the form-fitting portions of the securing mechanism engage behind a sensor arranged in the receiving portion on a side of the sensor facing away from the opening.

In this case, the receiving portion is not part of the mounting base, but is part of the securing mechanism. When the securing mechanism is located on the mounting base, the receiving portion of the securing mechanism extends substantially in an axial direction away from the opening. The sensor can be inserted into the receiving portion of the securing mechanism, which in turn is secured to the mounting base by the rotary closure.

In this case, the receiving portion has form-fitting portions at the end that is applied to the opening or at the edge region that is away from the opening. When the sensor is placed in the receiving portion of the securing mechanism, the form-fitting portions engage behind the side of the sensor facing away from the opening, thereby securing it in an axially positive manner.

In this example, the securing mechanism has a fastening portion adjacent to the receiving portion. The fastening portion of the securing mechanism is thereby arranged on the mounting base to form the rotary closure. For this purpose, the fastening portion preferably comprises the fastening elements. Correspondingly, the fastening receptacles are provided on the mounting base. In this embodiment, it is further suitable for the fastening elements to be formed as plate-shaped partial regions or projections of the fastening portion of the securing mechanism, which preferably protrude in a radial direction from the fastening portion. Correspondingly, approximately rectangular fastening receptacles or recesses are provided on the fastening base, the insertion openings of which are aligned in the circumferential direction. The securing mechanism is arranged with the fastening portion on the mounting base and by rotating the securing mechanism the preferably plate-shaped fastening elements of the fastening portion are guided into the insertion opening. Further rotation of the securing mechanism results in the formation of the rotary closure. To prevent loosening of the securing mechanism by rotation in the opposite direction, latching elements in the form of rising planes or wedges may be provided on the mounting base.

The receiving portion of the securing mechanism may be configured with an approximately cylindrical shape.

In some examples, the receiving portion of the securing mechanism is provided with first guide tongues, the form-fitting portions being arranged at the ends of the first guide tongues facing away from the opening. First, the securing mechanism may be arranged on the mounting base in the manner described above, wherein the rotary closure is formed by rotating the securing mechanism. The sensor is then inserted axially into the receiving portion of the securing mechanism. This allows the free-standing first guide tongues to yield or give way in the radial direction. When the sensor is fully inserted into the receiving portion, the first guide tongues snap back and the latching elements or form-fitting portions disposed at the ends of the guide tongues engage behind the side of the sensor facing away from the opening so that the sensor is positively secured at least in the axial direction.

Furthermore, the receiving portion may be configured with second guide tongues, the second guide tongues having penetrations, the penetrations being provided for engagement of latching elements of the sensor. In such a configuration, the sensor itself has, in particular in the radial direction, projecting latching elements which, when the sensor is inserted into the receiving portion of the securing mechanism, engage in the penetrations of the second guide tongues and latch with these. The result is a double security mechanism. On the one hand, the form-fitting portions of the first guide tongues engage behind the side of the sensor facing away from the opening and thus positively secure it in the axial direction. At the same time, the latching elements of the sensor, which protrude in the radial direction, engage in the penetrations of the second guide tongues and provide additional form-fit securing of the sensor in the receiving portion and thus in the mounting device.

Preferably, it is also provided that the first guide tongues and/or the second guide tongues are curved, in particular inwardly. It can also be provided that the first and/or second guide tongues are made of a metal and/or a plastic. In particular, it is provided that the first and/or the second guide tongues are formed elastically, preferably spring-elastically.

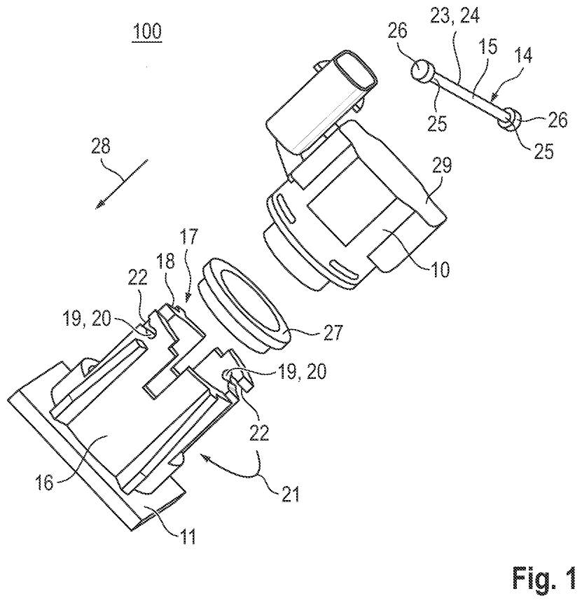

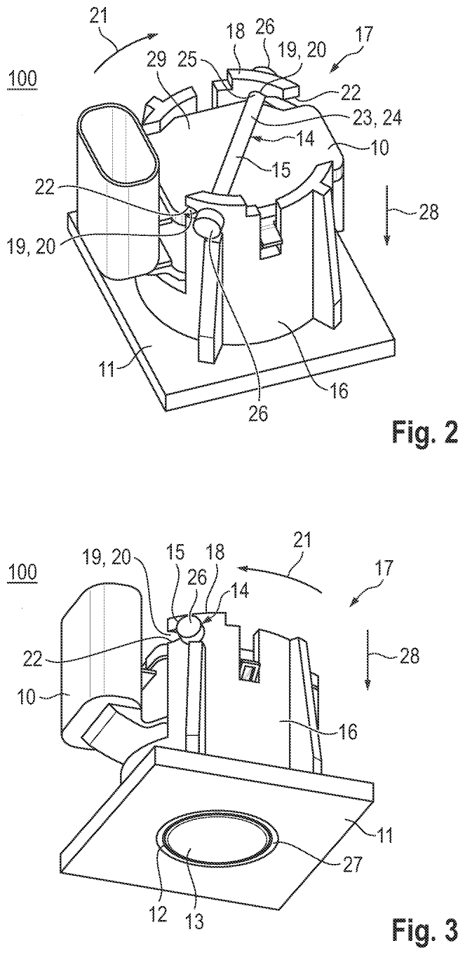

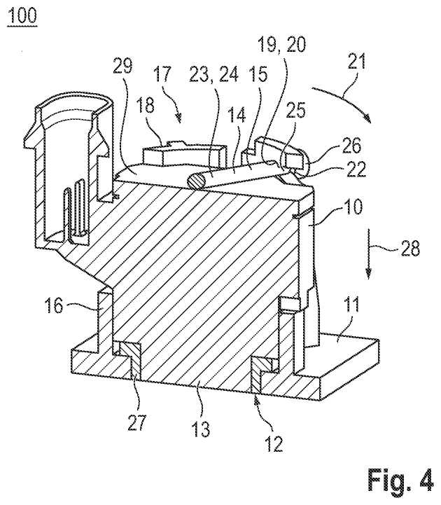

Turning now to the figures, FIGS. 1 to 4 show a first example of a mounting device 100 for mounting a sensor 10 on a vehicle component in accordance with some aspects of the present disclosure. The mounting device 100 comprises a mounting base 11 having an opening 12 for a receiving element 13 of a sensor 10. The mounting device 100 further comprises a securing mechanism 15 configured as a pin 14 or a bolt. The mounting base 11 comprises a receiving portion 16, wherein fastening receptacles 20 configured as recesses 19 are arranged at the end 17 facing away from the opening 12 or at the edge region 18 of the receiving portion 16 facing away from the opening 12. The recesses 19 have insertion openings 22 aligned in the circumferential direction 21.

The securing mechanism 15, which is configured as a pin 14 or bolt in this example, has a central part 23 that constitutes a form-fitting portion 24 of the securing mechanism 15. The portions of the pin 14 or bolt adjoining the central part 23 are formed as fastening elements 25, which in turn are adjoined by material thickenings 26. In order to fasten the sensor 10, a decoupling ring 27 is first inserted into the end 17 of the receiving portion 16 facing away from the opening 12 and brought up to the opening 12 for the receiving element 13 of the sensor 10. The sensor 10 is then inserted into the receiving portion 16 in the axial direction 28. In a next step, the pin 14 is brought up to the end 17 facing away from the opening 12 or to the edge region 18 of the receiving portion 16 facing away from the opening 12, so that the fastening elements 25 adjoining the form-fitting portion 24 or the central part 23 of the pin 14 on both sides are positioned in the region of the insertion openings 22 of the recesses 19.

By rotating the pin 14, the fastening elements 25 may be inserted into the insertion openings 22 until the fastening elements 25 and the fastening receptacles 20 or the recesses 19 form a rotary closure. To prevent reverse rotation of the pin 14, the insertion openings 22 have a smaller diameter than the remainder of the recesses 19 so that a snap or latch connection is formed. The material thickenings 26 adjoining the fastening elements 25 arranged at the ends of the central part 23 prevent axial slipping or displacement of the securing mechanism 15 formed as a pin 14, so that the pin 14 is prevented from sliding out of the recesses 19 in the axial direction of the pin 14. The central part 23 of the pin 14 engages over the side 29 of the sensor 10 facing away from the opening 12 to positively secure the sensor 10 in the axial direction 28.

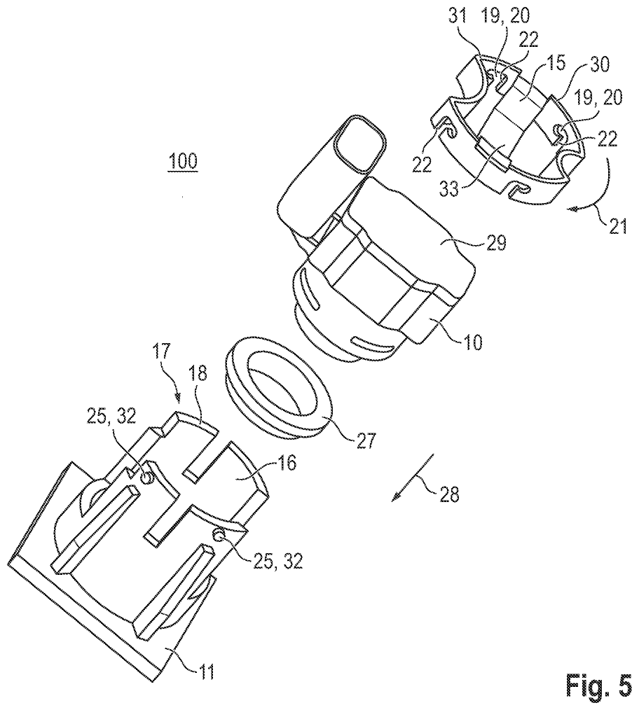

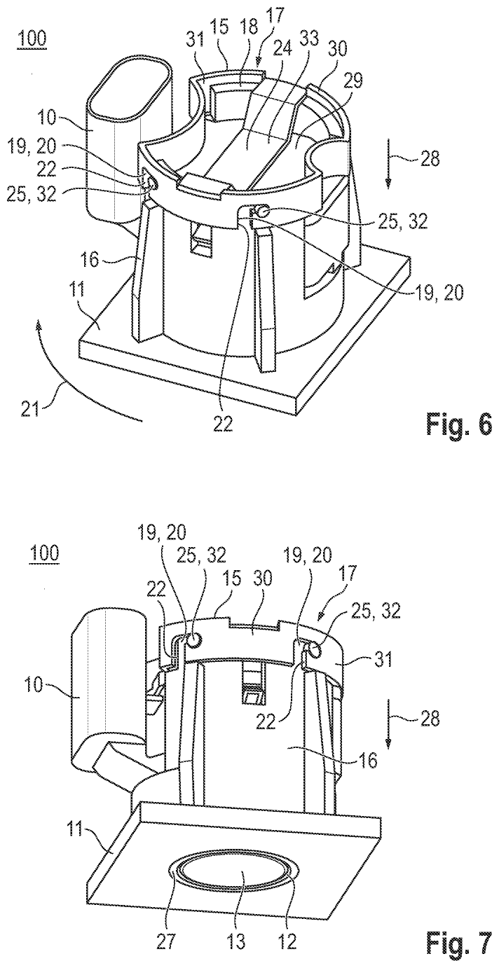

Further examples of a mounting device 100 according to the present disclosure are illustrated in FIGS. 5 to 7. In these examples, the mounting device 100 comprises a mounting base 11 having an opening 12 for a receiving element 13 of a sensor 10 and a securing mechanism 15 which is in the form of a retaining clip 30 or a latching clip. The retaining clip 30 comprises a ring portion 31 which is designed to enclose the end 17 facing away from the opening 12 or the edge region 18 of the receiving portion 16 of the mounting base 11 facing away from the opening 12.

Fastening elements 25 in the form of pin-shaped projections 32 extending radially outwards are provided at the end 17 of the receiving portion 16 facing away from the opening 12. In the ring portion 31 of the securing mechanism 15, there are provided fastening receptacles 20 in the form of recesses 19, the insertion openings 22 of which are aligned in the axial direction 28 in the direction of the opening 12. Transversely over the ring portion 31 there extends a form-fitting portion 24 in the form of a bracket 33, which is designed to be spring-elastic. After the decoupling ring 27 has been arranged in the mounting base 11, the sensor 10 is inserted in the axial direction 28 into the receiving portion 16 of the mounting base 11. The securing mechanism 15, which is in the form of a retaining clip 30, is then brought to the end 17 facing away from the opening 12 or to the edge region 18 of the receiving portion 16 facing away from the opening 12, so that the radially outwardly projecting pin-shaped fastening elements 25 or projections 32 of the receiving portion 16 are inserted into the insertion openings 22 of the securing mechanism 15.

Subsequent rotation of the securing mechanism 15 causes the pin-shaped fastening elements 25 of the receiving portion 16 to be inserted further into the recesses 19, so that they form a bayonet-type rotary closure. In the process, the bracket 33 extending transversely over the ring portion 31 engages behind the side 29 of the sensor 10 facing away from the opening 12 and thus positively secures the sensor 10 in the axial direction 28.

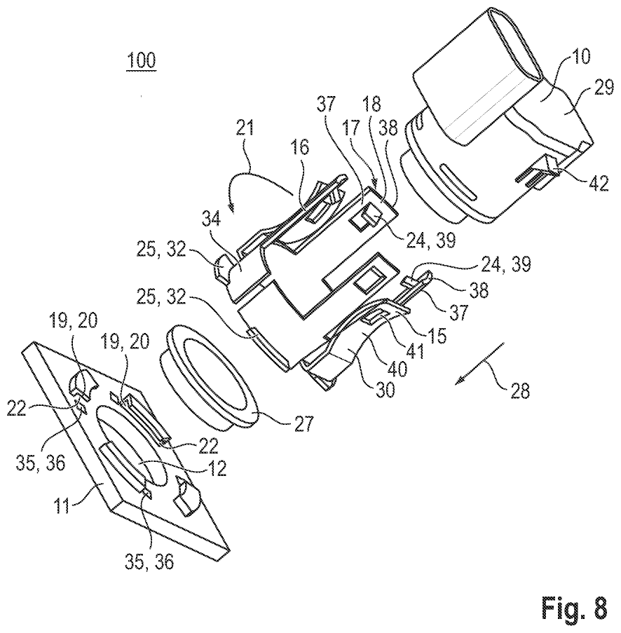

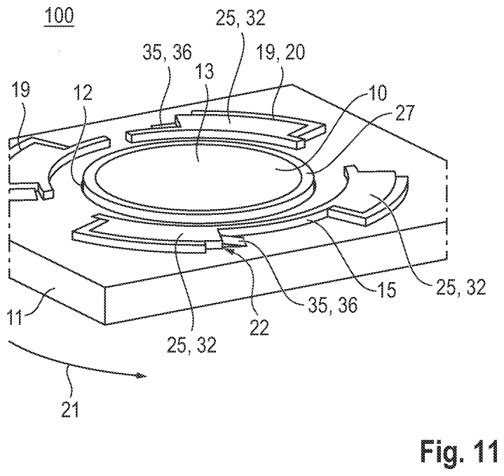

Further examples of a mounting device 100 according to the present disclosure are shown in FIGS. 8 to 11. In the mounting device 100 of FIG. 8 to 11, the receiving portion 16 is not formed as part of the mounting base 11, but as part of the securing mechanism 15. The securing mechanism 15, which may also be referred to as the retaining clip 30, comprises a fastening portion 34 and the receiving portion 16. Fastening elements 25 are provided on the fastening portion 34 in the form of plate-like, radially outwardly extending projections 32. In addition to the projections 32, fastening receptacles 20 are provided in the mounting base 11 in the form of slot-shaped or rectangular recesses 19 with insertion openings 22 aligned in the circumferential direction 21.

After arranging the decoupling ring 27 at the opening 12 for the receiving element 13 of the sensor 10, the securing mechanism 15 with its fastening portion 34 is brought to the mounting base 11 so that the plate-shaped fastening elements 25 come to lie next to the insertion openings 22 of the recesses 19. By rotating the securing mechanism 15 or the retaining clip 30, the plate-shaped fastening elements 25 are inserted into the insertion openings 22 of the recesses 19 and a rotary closure is formed. In order to prevent the securing mechanism 15 from turning back, latching elements 35 in the form of inclined planes 36 are provided on the mounting base 11. The receiving portion 16 has first guide tongues 37, at the free-standing ends 38 of which, facing away from the opening 12, form-fitting portions 24 in the form of latching elements 39 are provided.

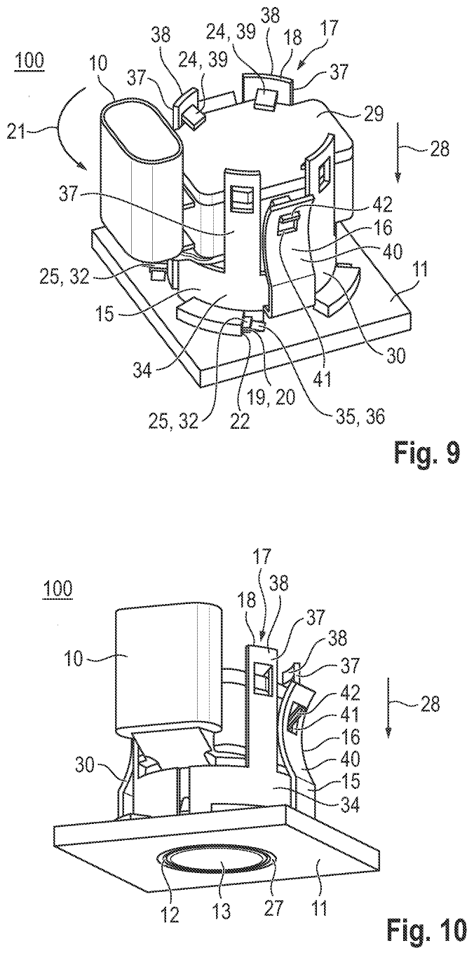

As shown in FIG. 9, these latching elements 39 engage behind the side 29 of the sensor 10 facing away from the opening 12 when said sensor is fully inserted into the receiving portion 16 and positively secure the sensor 10 in the axial direction. The receiving portion 16 further comprises second guide tongues 40 which are curved inwardly. The second guide tongues 40 have penetrations 41 in which radially outwardly projecting latching elements 42 of the sensor 10 engage. The sensor 10 is thus positively secured in the axial direction 28.

### LIST OF REFERENCE SIGNS

100 Mounting device
10 Sensor
11 Mounting base
12 Opening
13 Receiving element
14 Pin
15 Securing mechanism
16 Receiving portion
17 End
18 Edge region
19 Recess
20 Fastening receptacle
21 Circumferential direction
22 Insertion opening
23 Central part
24 Form-fitting portion
25 Fastening elements
26 Material thickenings
27 Decoupling ring
28 Axial direction
29 Side
30 Retaining clip
31 Ring portion
32 Projection
33 Bracket
34 Fastening portion
35 Latching element
36 Inclined plane
37 First guide tongue
38 End
39 Latching element
40 Second guide tongue
41 Penetration
42 Latching element

1. A mounting device for mounting a sensor on a vehicle component, comprising:
a mounting base comprising
at least one securing mechanism comprising one of (i) at least one fastening element or (ii) at least one fastening receptacle,
an opening for a receiving element of a sensor for configuring a sensor on the mounting base in an axial direction,
at least one fastening receptacle,
at least one fastening element, wherein the at least one securing mechanism is coupled to the mounting base by configuring the at least one fastening element in the at least one fastening receptacle, and wherein the at least one securing mechanism is configured to secure the sensor on the mounting base at least in the axial direction,
wherein the at least one fastening element and the at least one fastening receptacle are configured to form a rotary closure by inserting the at least one fastening element into the at least one fastening receptacle and rotating the securing mechanism.

2. The mounting device according to claim 1, wherein the at least one fastening element and the at least one fastening receptacle are configured to form a rotary closure by rotating the securing mechanism in a plane perpendicular to the axial direction and/or wherein the rotating of the securing mechanism for forming the rotary closure is less than 20°.

3. The mounting device according to claim 1, wherein the at least one fastening receptacle comprises an insertion opening and comprises a recess that is at least partially aligned in a circumferential direction of the mounting base or of the securing mechanism.

4. The mounting device according to claim 3, wherein the insertion opening is (i) oriented in the circumferential direction, or (ii) oriented in the axial direction.

5. The mounting device according to claim 1, wherein the at least one fastening element comprises one of a pin, bolt, or plate.

6. The mounting device according to claim 1, wherein the at least one fastening receptacle and the at least one fastening element are configured to produce one of (i) a snap connection, (ii) a latch connection, or (iii) a clip connection.

7. The mounting device according to claim 1, wherein the mounting base comprises a receiving portion for the sensor extending in an axial direction away from the opening, wherein the at least one fastening receptacle or the at least one fastening element is configured at an end facing away from the opening such that a form-fitting portion of the securing mechanism engages behind and/or bridges over the sensor arranged in the receiving portion on a side of the sensor facing away from the opening.

8. The mounting device according to claim 7, wherein the securing mechanism comprises a pin or bolt, and the form-fitting portion being configured as a central part of the pin or bolt, and wherein one fastening element is configured at an end face of the central part, and wherein material thickenings are configured at the end face of the central part.

9. The mounting device according to claim 8, wherein the securing mechanism comprises a ring portion surrounding an end facing away from the opening of the receiving portion, the ring portion comprising the fastening receptacle and the form-fitting portion forming a bracket extending transversely over the ring portion.

10. The mounting device according to claim 7, wherein the securing mechanism comprises a receiving portion for the sensor extending substantially in the axial direction away from the opening when configured on the mounting base, and wherein the receiving portion comprises form-fitting portions at an end facing away from the opening, the form-fitting portions of the securing mechanism being configured to engage behind the sensor arranged in the receiving portion on a side of the sensor facing away from the opening.

11. The mounting device according to claim 10, wherein
the receiving portion comprises first guide tongues, and the form-fitting portions are configured at ends of the first guide tongues facing away from the opening, and/or
the receiving portion comprises second guide tongues, the second guide tongues comprising penetrations for the engagement of latching elements of the sensor.

12. The mounting device according to claim 11, wherein the first guide tongues and/or the second guide tongues are curved.

13. A vehicle component comprising:
a mounting device for mounting a sensor on the vehicle component, the mounting device comprising:
a mounting base comprising
at least one securing mechanism comprising one of (i) at least one fastening element or (ii) at least one fastening receptacle,
an opening for a receiving element of a sensor for configuring a sensor on the mounting base in an axial direction,
at least one fastening receptacle,
at least one fastening element, wherein the at least one securing mechanism is coupled to the mounting base by configuring the at least one fastening element in the at least one fastening receptacle, and wherein the at least one securing mechanism is configured to secure the sensor on the mounting base at least in the axial direction,
wherein the at least one fastening element and the at least one fastening receptacle are configured to form a rotary closure by inserting the at least one fastening element into the at least one fastening receptacle and rotating the securing mechanism.

14. The vehicle according to claim 13, wherein the at least one fastening element and the at least one fastening receptacle are configured to form a rotary closure by rotating the securing mechanism in a plane perpendicular to the axial direction and/or wherein the rotating of the securing mechanism for forming the rotary closure is less than 20°.

15. The vehicle according to claim 13, wherein the at least one fastening receptacle comprises an insertion opening and comprises a recess that is at least partially aligned in a circumferential direction of the mounting base or of the securing mechanism.

16. The vehicle according to claim 15, wherein the insertion opening is (i) oriented in the circumferential direction, or (ii) oriented in the axial direction.

17. The vehicle according to claim 13, wherein the at least one fastening element comprises one of a pin, bolt, or plate.

18. The vehicle according to claim 13, wherein the at least one fastening receptacle and the at least one fastening element are configured to produce one of (i) a snap connection, (ii) a latch connection, or (iii) a clip connection.

19. The vehicle according to claim 18, wherein the mounting base comprises a receiving portion for the sensor extending in an axial direction away from the opening, wherein the at least one fastening receptacle or the at least one fastening element is configured at an end facing away from the opening such that a form-fitting portion of the securing mechanism engages behind and/or bridges over the sensor arranged in the receiving portion on a side of the sensor facing away from the opening.

20. A mounting device for mounting a sensor on a vehicle component, comprising:
a mounting base comprising
at least one securing mechanism comprising one of (i) at least one fastening element or (ii) at least one fastening receptacle,
an opening for a receiving element of a sensor in an axial direction,
at least one fastening receptacle,
at least one fastening element, wherein the at least one securing mechanism is coupled to the mounting base by configuring the at least one fastening element in the at least one fastening receptacle, and wherein the at least one securing mechanism is configured to secure the sensor arranged on the mounting base at least in the axial direction,
wherein the at least one fastening element and the at least one fastening receptacle are configured to form a rotary closure in which the at least one fastening element may be inserted into the at least one fastening receptacle by rotating the securing mechanism.
